(19) United States
(12) Patent Application Publication
(10) Pub. No.: US 2004/0251675 A1
(43) Pub. Date: Dec. 16, 2004

(54) Four-point vehicle occupant restraint system with anchor pretensioners

(75) Inventors: Arnold J. Herberg, Davisburg, MI (US); Joseph J. Zwolinski, Sterling Heights, MI (US)

Correspondence Address: TAROLLI, SUNDHEIM, COVELL & TUMMINO L.L.P., 1111 LEADER BLDG., 526 SUPERIOR AVENUE, CLEVELAND, OH, 44114-1400, US

(73) Assignee: TRW Vehicle Safety Systems Inc.

(21) Appl. No.: 10/460,116

(22) Filed: Jun. 12, 2003

(51) Int. Cl. B60R 22/46

(52) U.S. Cl. 280/806

(57) ABSTRACT

An occupant restraint system (30) includes first and second lap belts (32 and 34) for collectively extending across a lap of the occupant (18) and first and second shoulder belts (36 and 38) for extending over the shoulders of the occupant (18). A buckle assembly (90) interconnects the lap belts (32 and 34) and the shoulder belts (36 and 38). The occupant restraint system (30) also includes first and second lap belt anchors (42 and 102). At least one pretensioner (130, 140) is connected with the first and second lap belt anchors (42 and 102) and is actuatable to move the first and second lap belt anchors (42 and 102) for tensioning the first and second lap belt portions (32 and 34) simultaneously and uniformly.

### TECHNICAL FIELD

The present invention relates to an occupant restraint system for a vehicle. More particularly, the present invention relates to a four-point seat belt system having anchor pretensioners that are actuatable for tensioning lap belts.

### BACKGROUND OF THE INVENTION

A conventional four-point seat belt system includes two lap belts and two shoulder belts. A first lap belt extends upwardly from a first lap belt retractor mounted on a right side of the vehicle seat and is fixed to a first portion of a buckle assembly. A second lap belt extends upwardly from a second lap belt retractor mounted on a left side of the vehicle seat and is fixed to a second portion of the buckle assembly. A first shoulder belt extends from a first shoulder belt retractor downward to the first portion of the buckle assembly. A second shoulder belt extends from a second shoulder belt retractor downward to the second portion of the buckle assembly. The first and second portions of the buckle assembly latch together to secure the four-point seat belt system about the occupant.

### SUMMARY OF THE INVENTION

The present invention relates to an occupant restraint system for helping to protect an occupant of a vehicle. The occupant restraint system comprises first and second lap belt portions for collectively extending across a lap of the occupant and first and second shoulder belt portions for extending over the shoulders of the occupant. A buckle assembly interconnects the lap belt portions and the shoulder belt portions. The occupant restraint system also comprises first and second lap belt anchors for the first and second lap belt portions, respectively, and for transferring loads from the first and second lap belt portions. At least one pretensioner is connected with the first and second lap belt anchors and is actuatable to move the first and second lap belt anchors for tensioning the first and second lap belt portions. The occupant restraint system also includes a crash sensor for sensing a vehicle crash condition and a controller that is responsive to the crash sensor for controlling actuation of the pretensioner. The controller controls the pretensioner to tension the first and second lap belt portions simultaneously and uniformly.

According to another aspect, the present invention relates to an occupant restraint system for helping to protect an occupant of a vehicle. The occupant restraint system comprises first and second lap belt portions for collectively extending across a lap of the occupant and first and second shoulder belt portions for extending over the shoulders of the occupant. The occupant restraint system also comprises a buckle assembly for interconnecting the lap belt portions and the shoulder belt portions. The occupant restraint system further comprises at least one lap belt retractor for the first and second lap belt portions. First and second turning loops are located between the lap belt retractor and the buckle assembly for guiding the first and second lap belt portions, respectively. At least one pretensioner is connected with the first and second turning loops and is actuatable to move the first and second turning loops for tensioning the first and second lap belt portions.

According to yet another aspect, the present invention relates to an occupant restraint system for helping to protect an occupant of a vehicle. The occupant restraint system comprises first and second lap belt portions for collectively extending across a lap of the occupant. A buckle assembly interconnects the first and second lap belt portions. The occupant restraint system also comprises at least one lap belt retractor for the first and second lap belt portions. First and second turning loops are located between the lap belt retractor and the buckle assembly for guiding the first and second lap belt portions, respectively. At least one pretensioner is connected with at least one of the first and second turning loops and is actuatable to move the turning loop for tensioning the first and second lap belt portions.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a schematic illustration of an occupant restraint system constructed in accordance with the present invention;

FIG. 2 is a schematic side view of the occupant restraint system of FIG. 1;

FIG. 3 illustrates an enlarged view of an unactuated pretensioner of the occupant restraint system of FIG. 1;

FIG. 4 illustrates the pretensioner of FIG. 3 in an actuated condition;

FIG. 5 illustrates a pretensioner, in an unactuated condition, for an occupant restraint system constructed in accordance with a second embodiment of the present invention;

FIG. 6 illustrates the pretensioner of FIG. 5 in an actuated condition;

FIG. 7 is a schematic illustration of an occupant restraint system constructed in accordance with a third embodiment of the present invention;

FIG. 8 is a schematic side view of the occupant restraint system of FIG. 7;

FIG. 9 illustrates the occupant restraint system of FIG. 8 with the pretensioner in an actuated condition; and

FIG. 10 illustrates an occupant restraint system similar to that of FIG. 8 with the pretensioner in an alternate location.

### DETAILED DESCRIPTION OF THE INVENTION

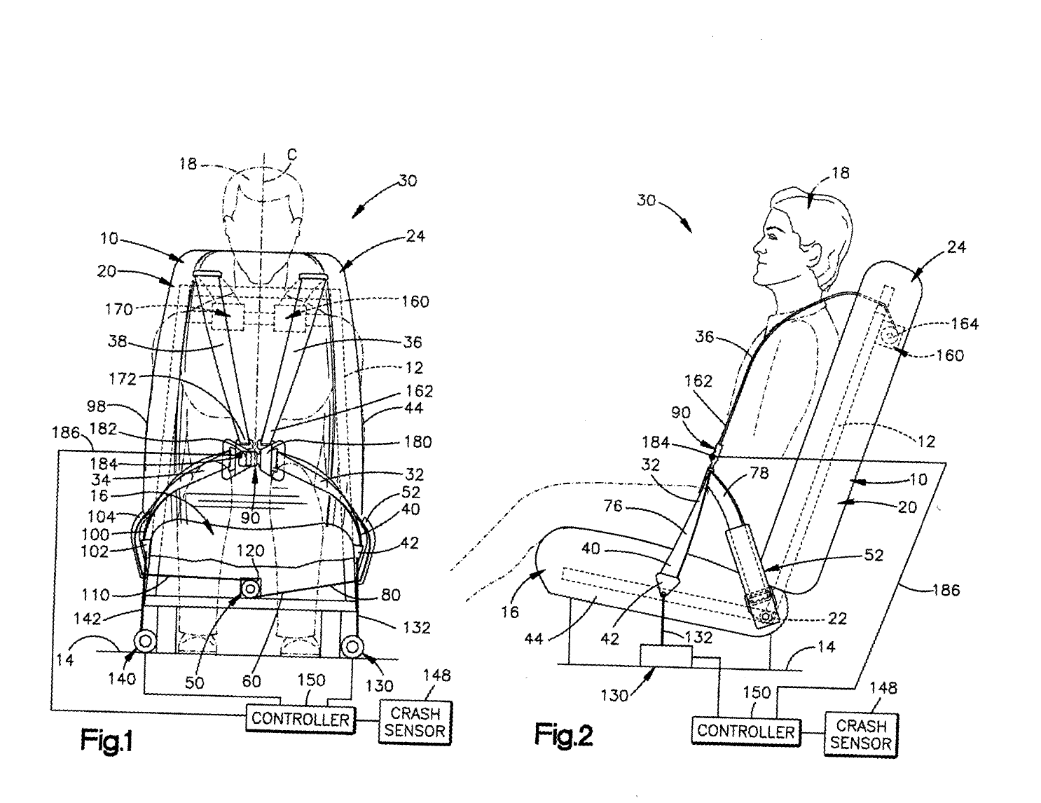

A vehicle seat 10 is shown in FIGS. 1 and 2. The seat 10 includes a frame 12 that is secured to the vehicle 14 in a known manner. The seat 10 also includes a cushion portion 16 upon which a vehicle occupant 18 sits and a backrest portion 20 that extends upwardly from the cushion portion. A hinge 22 (FIG. 2) connects the backrest portion 20 of the seat 10 to the cushion portion 16 of the seat. An upper portion 24 of the backrest portion 20 of the seat 10 is located adjacent the shoulders of the seated occupant 18.

FIGS. 1 and 2 also illustrate a vehicle restraint system 30 for helping to restrain the occupant 18 in the seat 10. The vehicle restraint system 30 illustrated in FIGS. 1 and 2 may be referred to as a “four-point seat belt system.” The four-point seat belt system 30 includes lap belts 32 and 34 and shoulder belts 36 and 38. Each lap belt 32 and 34 is extensible over a portion of the lap of the occupant 18 and each shoulder belt 36 and 38 is extensible over an associated shoulder of the occupant.

Lap belt 32 has an end 40 that is connected to an anchor 42 adjacent the left side 44 of the seat 10. The anchor 42 is attached to the left side 44 of the seat 10 with a breakaway connector (not shown). The breakaway connector is designed to secure the anchor 42 relative to the seat 10 during normal use of the four-point seat belt system 30. As used herein, the term “anchor” refers to a point of primary loading from the seat belt webbing to either the seat or the vehicle at a location other than a retractor. As shown in FIG. 2, the anchor 42 is located near a midpoint of the frame 12 of the cushion portion 16 of the seat 10.

An opposite end (not shown) of lap belt 32 is connected to a lap belt retractor 50 (FIG. 1). The lap belt retractor 50 is mounted to the frame 12 of the seat 10 in a location below the cushion portion 16 of the seat.

A tubular lap belt guide 52 is attached to the frame 12 on the left side 44 of the seat 10. The lap belt guide 52 includes a D-ring portion (not shown) at which the lap belt 32 turns toward the lap belt retractor 50.

A first length 76 (FIG. 2) of lap belt 32 extends from end 40 upward to a buckle assembly 90. A second length 78 (FIG. 2) of lap belt 32 extends downwardly from the buckle assembly 90, into the lap belt guide 52, and partially around the D-ring portion of the lap belt guide. The first length 76 is oriented at an acute angle relative to the second length 78. The direction of lap belt 32 changes at the D-ring portion of the lap belt guide 52. A third length 80 (FIG. 1) of lap belt 32 extends from the D-ring portion of the lap belt guide 52 to the lap belt retractor 50.

The sum of the first, second, and third lengths 76, 78, and 80, respectively, of lap belt 32 equals the withdrawn length of lap belt 32. Pulling upwardly on the second length 78 to withdraw lap belt 32 from the lap belt retractor 50 varies the withdrawn length of lap belt 32.

Lap belt 34 is similar in construction to lap belt 32. Lap belt 34 has an end 100 (FIG. 1) that is connected to an anchor 102 adjacent the right side 98 of the seat 10. The anchor 102 is attached to the right side 98 of the seat 10 with a breakaway connector (not shown). The breakaway connector is designed to secure the anchor 102 relative to the seat 10 during normal use of the four-point seat belt system 30. The anchor 102 is located near a midpoint of the frame 12 of the cushion portion 16 of the seat 10. An opposite end (not shown) of lap belt 34 is connected to the lap belt retractor 50.

A tubular lap belt guide 104 is attached to the right side 98 of the seat 10. The tubular lap belt guide 104 is similar to the lap belt guide 52 illustrated in FIG. 2. The lap belt guide 104 also includes a D-ring portion (not shown) at which lap belt 34 turns toward the lap belt retractor 50.

A first length of lap belt 34 extends from end 100 and upward to the buckle assembly 90. A second length of lap belt 34 extends downwardly from the buckle assembly 90, into the lap belt guide 104, and partially around the D-ring portion of the lap belt guide 104. The first length is oriented at an acute angle relative to the second length. A third length 110 (FIG. 1) of lap belt 34 extends from the D-ring portion of the lap belt guide 104 to the lap belt retractor 50.

The sum of the first, second, and third lengths of lap belt 34 equals the withdrawn length of lap belt 34. Pulling upwardly on the second length to withdraw lap belt 34 from the lap belt retractor 50 varies the withdrawn length of lap belt 34.

The lap belt retractor 50 illustrated in FIG. 1 is a dual payout retractor and includes a single spool 120 (FIG. 1) for receiving both lap belts 32 and 34. As shown in FIG. 1, lap belt 32 extends from a lower side of the spool 120 and toward lap belt guide 52. Lap belt 34 extends from an upper side of the spool 120 and toward lap belt guide 104. Thus, rotation of the spool 120 in a clockwise direction, as viewed in FIG. 1, results in the retraction of both lap belts 32 and 34, and rotation of the spool 120 in a counterclockwise direction, as viewed in FIG. 1, results in the withdrawal of both lap belts 32 and 34.

The lap belt retractor 50 includes a rewind spring (not shown) and a locking mechanism (not shown). The rewind spring is connected with the spool 120 and applies a force to the spool for rotating the spool in the clockwise direction, as viewed in FIG. 1. The locking mechanism is of a known design and is responsive to a predetermined deceleration of the vehicle 14 for preventing rotation of the spool 120 of the lap belt retractor 50 in a counter-clockwise direction, as viewed in FIG. 1. Alternatively, the locking mechanism may be responsive to a predetermined acceleration of spool 120.

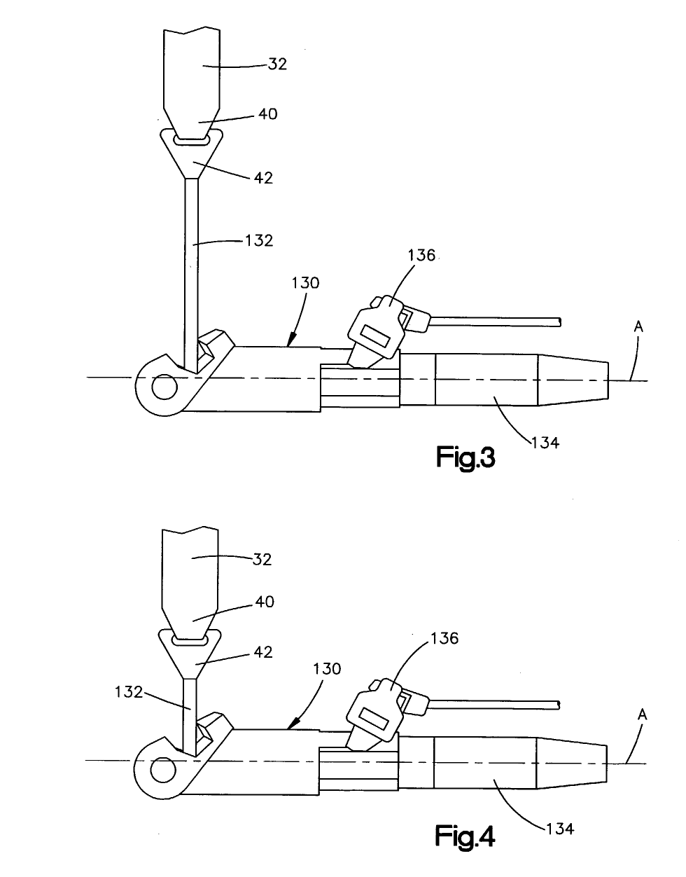

Anchor 42 is connected with a pretensioner 130. An anchor cable 132, such as a braided metal cable, extends between the anchor 42 and the pretensioner 130. FIGS. 3 and 4 are enlarged views of the pretensioner 130. FIG. 3 illustrates the pretensioner 130 in an unactuated condition and FIG. 4 illustrates the pretensioner 130 in an actuated condition.

The pretensioner 130 includes a cylinder 134 that extends along axis A. A piston (not shown) is located within the cylinder 134. An end of the anchor cable 132 is attached to the piston of the pretensioner 130. The pretensioner 130 also includes a squib 136. The squib 136 is attached to the cylinder 134 of the pretensioner 130. The squib 136 includes a pyrotechnic charge that, when actuated, forces the piston of the pretensioner 130 to move within the cylinder 134 and pull the anchor 42 downward into the position shown in FIG. 4. The downward force on the anchor 42 causes the breakaway connector on the left side 44 of the seat 10 to break and enable the downward movement of the anchor 42.

Anchor 102 is also connected with a pretensioner 140. An anchor cable 142, such as a braided metal cable, extends between the anchor 102 and the pretensioner 140. Pretensioner 140 is identical in construction to pretensioner 130. When pretensioner 140 is actuated, anchor 102 is moved downward. The downward force on the anchor 102 causes the breakaway connector on the right side 98 of the seat 10 to break and enable the downward movement of the anchor 102.

The four-point seat belt system 30 also includes a crash sensor 148, shown in FIGS. 1 and 2. The crash sensor 148 is a known device that senses a vehicle condition indicating the occurrence of a crash. Such a condition may comprise, for example, vehicle deceleration. The crash sensor 148 outputs signals indicative of the crash condition.

As is shown schematically in FIG. 1, the pretensioners 130 and 140 are electrically connected to a controller 150. The controller 150 is preferably a microcomputer that receives signals from the crash sensor 148 and runs a known algorithm for determining when seat belt tensioning is desirable. Actuation of the pretensioners 130 and 140 only occurs at conditions in which the locking mechanism of the lap belt retractor 50 has already been actuated to block further withdrawal of the lap belts 32 and 34. When the controller 150 determines that seat belt tensioning is desirable, the controller 150 outputs actuation signals to the squibs (only squib 136 being shown in FIGS. 3 and 4) of the pretensioners 130 and 140 to actuate the pretensioners 130 and 140 simultaneously. In response to the actuation signal from the controller 150, the squib 136 of the pretensioner 130 is actuated to pull anchor 42 downward. Similarly, in response to the actuation signal from the controller 150, the squib (not shown) of the pretensioner 140 is actuated to pull anchor 102 downward.

Each of the shoulder belts 36 and 38 of the four-point seat belt system 30 extends outwardly from the upper portion 24 of the backrest portion 20 of the seat 10. Shoulder belt 36 is associated with a left shoulder of the occupant 18, and shoulder belt 38 is associated with the right shoulder of the occupant.

Shoulder belt 36 has a first end (not shown) that is connected with shoulder belt retractor 160 and a second end 162 that is connected to the buckle assembly 90. Shoulder belt retractor 160 is mounted on the frame 12 of the backrest portion 20 of the seat 10. When the occupant 18 is seated in the seat 10, as shown in FIG. 1, shoulder belt 36 extends over the left shoulder of the occupant 18.

Shoulder belt retractor 160 includes a spool 164 (FIG. 2). The first end of shoulder belt 36 is secured to the spool 164 of shoulder belt retractor 160 and a portion of shoulder belt 36 is wound around the spool.

Shoulder belt retractor 160 includes a rewind spring (not shown) and a locking mechanism (not shown). The rewind spring is connected with the spool 164 and applies a force to the spool for rotating the spool in the clockwise direction, as viewed in FIG. 2. The locking mechanism is of a known design and is responsive to a predetermined deceleration of the vehicle 14 for preventing rotation of the spool 164 of the shoulder belt retractor 160 in the counter-clockwise direction, as viewed in FIG. 2. Alternatively, the locking mechanism may be responsive to a predetermined acceleration of spool 164.

Shoulder belt 38 has a first end (not shown) that is connected with shoulder belt retractor 170 (FIG. 1) and a second end 172 that is connected to the buckle assembly 90. Shoulder belt retractor 170 is mounted on the frame 12 of the backrest portion 20 of the seat 10. When an occupant 18 is seated in the seat 10, as shown in FIG. 1, shoulder belt 38 extends over the right shoulder of the occupant 18.

Shoulder belt retractor 170 includes a spool (not shown). The first end of shoulder belt 38 is secured to the spool of shoulder belt retractor 170 and a portion of shoulder belt 38 is wound around the spool.

Shoulder belt retractor 140 also includes a rewind spring (not shown) and a locking mechanism (not shown). The rewind spring is connected with the spool and applies a force to the spool for rotating the spool in a direction for retracting shoulder belt 38. The locking mechanism is of a known design and is responsive to a predetermined deceleration of the vehicle 14 for preventing rotation of the spool of the shoulder belt retractor 170 in a direction enabling withdrawal of the lap belt 34. Alternatively, the locking mechanism may be responsive to a predetermined acceleration of the spool of shoulder belt retractor 170.

The rewind spring of the lap belt retractor 50 applies a rewind force to the spool 120 of the lap belt retractor that is greater than the combined forces of the rewind springs of shoulder belt retractors 160 and 170. Thus, when the lap belts 32 and 34 and the shoulder belts 36 and 38 are connected together at the buckle assembly 90, the rewind spring of the lap belt retractor 50 holds the buckle assembly 90 in position atop the lap of the occupant 18.

The buckle assembly 90 of the four-point seat belt system 30 includes first and second buckle members 180 and 182, respectively (FIG. 1). The first buckle member 180 includes a lap belt connecting portion and a shoulder belt connecting portion, both of which are slotted belt guides. A tongue assembly extends outwardly of the first buckle member 180. Lap belt 32 passes through the lap belt connecting portion of the first buckle member 180. The first buckle member 180 is slidable on lap belt 32 to enable the position of the first buckle member 180 relative to lap belt 32 to be adjusted. End 162 of shoulder belt 36 is fixed to the shoulder belt connecting portion of the first buckle member 180.

The second buckle member 182 also includes a lap belt connecting portion and a shoulder belt connecting portion, both of which are slotted belt guides. A latch mechanism also forms a portion of the second buckle member 182. Lap belt 34 passes through the lap belt connecting portion of the second buckle member 182. The second buckle member 182 is slidable on lap belt 34 to enable the position of the second buckle member 182 relative to lap belt 34 to be adjusted. End 172 of shoulder belt 38 is fixed to the shoulder belt connecting portion of the second buckle member 182.

The latch mechanism of the second buckle member 182 includes a buckle switch, shown schematically at 184. When the tongue assembly of the first buckle member 180 is received in and is latched by the latch mechanism of the second buckle member 182, the buckle switch 184 outputs an electronic signal to the controller 150 indicating the latched condition of the buckle assembly 90. The electronic signal may be transferred through a wire, shown schematically at 186 in FIG. 2, that may be embedded in the webbing of one of lap belts 32 or 34. Alternatively, the electronic signal may be transferred by wireless communication such as by a radio frequency signal. Other methods and devices for determining the latched condition of the buckle assembly 90 are also contemplated by this invention.

The controller 150 is responsive to the electric signal from the buckle switch 184 for determining whether to actuate the pretensioners 130 and 140. If the controller 150 receives a signal indicating that the buckle assembly 90 is not latched, the controller 150 prevents actuation of the pretensioners 130 and 140. If the controller 150 receives a signal indicating that the buckle assembly 90 is latched, the controller 150 enables actuation of the pretensioners 130 and 140.

Since pretensioner 140 is identical to pretensioner 130, the simultaneous actuation of the pretensioners 130 and 140 applies equal forces to lap belts 32 and 34 so as to pull the buckle assembly 90 downward along the centerline C (FIG. 1) of the occupant 18 of the vehicle 14. Thus, the four-point seat belt system 30 of the present invention, upon actuation of the pretensioners 130 and 140, maintains the buckle assembly 90 in a centered position relative to the occupant 18 for helping to restrain the occupant in the seat 10.

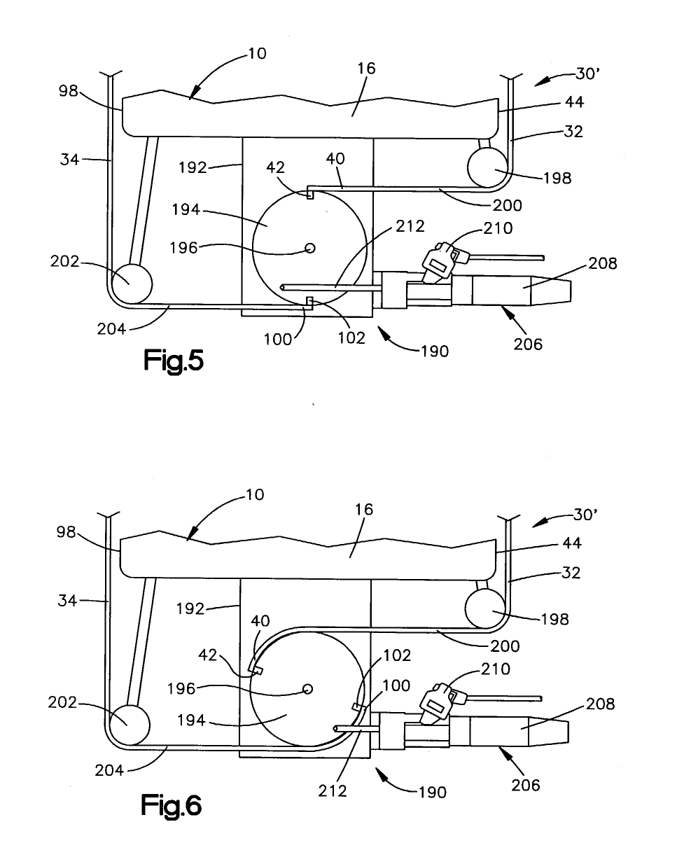

FIGS. 5 and 6 illustrate a pretensioner 190 of a four-point seat belt system 30′ constructed in accordance with a second embodiment of the present invention. Structures illustrated in FIGS. 5 and 6 that are the same as or perform similar functions as structures of FIGS. 1 and 2 are labeled with the same reference number as in FIGS. 1 and 2.

The pretensioner 190 illustrated in FIGS. 5 and 6 replaces both pretensioners 130 and 140 shown in FIG. 1. FIG. 5 shows the pretensioner 190 in an unactuated condition and FIG. 6 shows the pretensioner 190 in an actuated condition.

The pretensioner 190 includes a housing 192. A drum 194 is located within the housing 192. The drum 194 includes a cylindrical axle 196. The housing 192 rotatably supports opposite ends of the axle 196 and enable rotation of the drum 194 relative to the housing. The housing 192 is mounted to the frame of the seat 10 in a location below the cushion portion 16 of the seat.

Lap belt 32 passes over a first turning loop 198. The first turning loop 198 is mounted below the cushion portion 16 of the seat 10 adjacent the left side 44 of the seat. A horizontally extending portion 200 of lap belt 32 extends into a first opening in the housing 192. Anchor 42 secures the end 40 of lap belt 32 to an upper portion, as viewed in FIG. 5, of the drum 194. Preferably, anchor 42 consists of one or more rivets that secure the end 40 of lap belt 32 to the drum 194.

Lap belt 34 passes over a second turning loop 202. The second turning loop 202 is mounted below the cushion portion 16 of the seat 10 adjacent the right side 98 of the seat. A horizontally extending portion 204 of lap belt 34 extends into a second opening in the housing 192. Anchor 102 secures the end 100 of lap belt 34 to a lower portion, as viewed in FIG. 5, of the drum 194. Preferably, anchor 102 consists of one or more rivets that secure the end 100 of lap belt 34 to the drum 194.

The pretensioner 190 also includes an actuation mechanism 206. The actuation mechanism 206 includes a cylinder 208. The housing 192 supports the cylinder 208. A piston (not shown) is located within the cylinder 208 and is movable axially within the cylinder. The actuation mechanism 206 also includes a squib 210. The squib 210 is attached to the cylinder 208 and includes a pyrotechnic charge that, when actuated, forces the piston to move rightward, as viewed in FIGS. 5 and 6, within the cylinder 208.

An actuation cable 212 includes a first end that is fixedly attached to a lower portion of the drum 194, as shown in FIG. 5, and a second end that is fixedly connected to the piston of the actuation mechanism 206. The actuation cable 212 extends through a third opening in the housing 192.

When the squib 210 of the actuation mechanism 206 of the pretensioner 190 is actuated, the piston moves rightward in the cylinder 208 of the actuation mechanism. This rightward movement of the piston pulls the actuation cable 212 rightward causing counter-clockwise rotation, as viewed in FIGS. 5 and 6, of the drum 194. The counter-clockwise rotation of the drum 194 moves anchors 42 and 102 and partially winds lap belts 32 and 34 about the drum. As a result of the movement of the anchors 42 and 102 on the drum 194 and relative to the seat 10, the lap belts 32 and 34 are pulled downward simultaneously and with equal force so that a buckle assembly of the four-point seat belt system 30′ is moved downward along a centerline of the occupant.

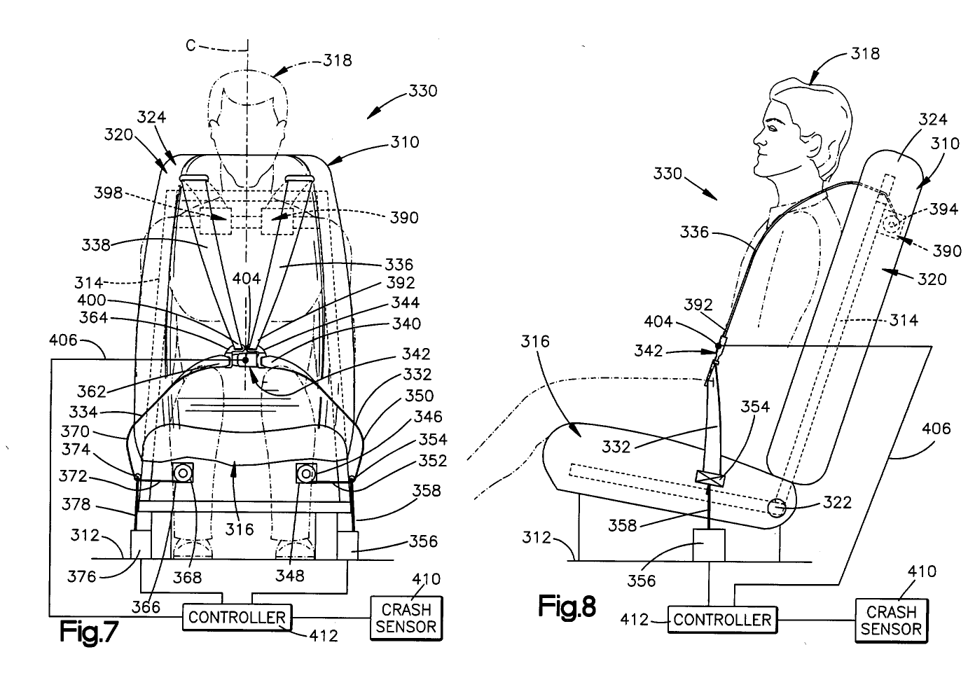

FIGS. 7 and 8 illustrate a seat 310 for a vehicle 312. The seat 310 includes a frame 314 that is secured to the vehicle 312 in a known manner. The seat 310 also includes a cushion portion 316 upon which a vehicle occupant 318 sits and a backrest portion 320 that extends upwardly from the cushion portion. A hinge 322 (FIG. 8) connects the backrest portion 320 of the seat 310 to the cushion portion 316 of the seat. An upper portion 324 of the backrest portion 320 of the seat 310 is located adjacent the shoulders of the seated occupant 318.

FIGS. 7 and 8 also illustrate a four-point seat belt system 330 constructed in accordance with a third embodiment of the present invention for helping to retain the occupant 318 in the seat 310. The four-point seat belt system 330 includes lap belts 332 and 334 and shoulder belts 336 and 338. Each lap belt 336 and 338 extends over a portion of the lap of the seated occupant 318 so that lap belts collectively extend across the occupant's lap. Each shoulder belt 336 and 338 extends over an associated shoulder of the occupant 318.

Lap belt 332 has opposite first and second ends. A first end 340 of lap belt 332 is fixedly attached to a first portion 344 of a buckle assembly 342 and a second end (not shown) of lap belt 332 is secured to a spool 346 of a lap belt retractor 348. The lap belt retractor 348 is mounted to the frame 314 of the seat 310 in a location within the cushion portion 316 of the seat.

The lap belt retractor 348 includes a rewind spring (not shown) and a locking mechanism (not shown). The rewind spring is connected with the spool 346 and applies a force to the spool for rotating the spool in a direction for retracting lap belt 332. The locking mechanism is of a known design and is responsive to a predetermined deceleration of the vehicle 312 for preventing rotation of the spool 346 of the lap belt retractor 348 in a direction enabling withdrawal of lap belt 332. Alternatively, the locking mechanism may be responsive to a predetermined acceleration of the spool 346.

Lap belt 332, between the buckle assembly 342 and the lap belt retractor 348, includes a vertically extending portion 350 and a horizontally extending portion 352. Lap belt 332 transitions from the vertically extending portion 350 to the horizontally extending portion 352 at a turning loop 354. The turning loop 354 guides lap belt 332 relative to the seat 310 during the transition from the vertically extending portion 350 to the horizontally extending portion 352.

The turning loop 354 is located adjacent a left side of the cushion portion 316 of the seat 310. The turning loop 354 is attached to the left side of the seat 310 with a breakaway connector (not shown). The breakaway connector is designed to secure the turning loop 354 relative to the seat 310 during normal use of the four-point seat belt system 330. Preferably, the turning loop 354 is a D-ring. The turning loop 354 is a point of primary loading between lap belt 332 and the seat 310. Thus, the turning loop 354 is an anchor as defined herein.

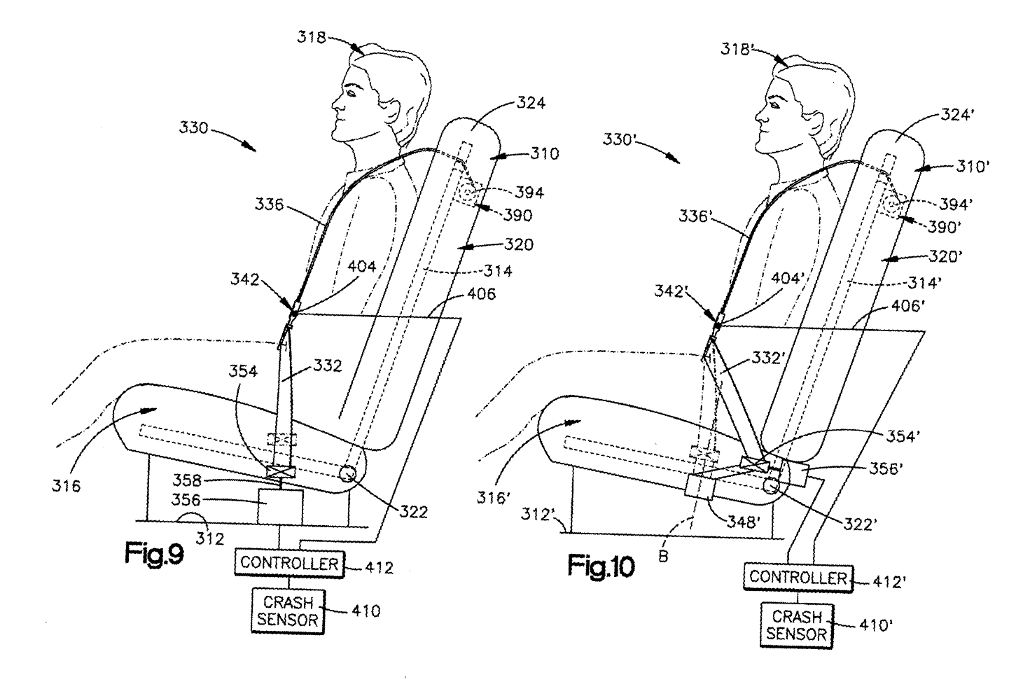

The turning loop 354 is connected with a pretensioner 356. The pretensioner 356 is located directly below the turning loop 354. An anchor cable 358, such as a braided metal cable, extends between the turning loop 354 and the pretensioner 356. The pretensioner 356 is of a known design and is actuatable for pulling turning loop 354 downwardly, as viewed in FIG. 8. When the pretensioner 356 is actuated, the downward force exerted on the turning loop 354 causes the breakaway connector to break and enable downward movement of the turning loop 354. FIG. 8 illustrates the pretensioner 356 in an unactuated condition and FIG. 9 illustrates the pretensioner 356 in an actuated condition with the turning loop 354 moved downward relative to the seat 310.

Lap belt 334 has opposite first and second ends. A first end 362 of lap belt 334 is fixedly attached to a second portion 364 of a buckle assembly 342 and a second end (not shown) of lap belt 334 is secured to a spool 368 of a lap belt retractor 366. The lap belt retractor 366 is mounted to the frame 314 of the seat 310 at a location within the cushion portion 316 of the seat.

The lap belt retractor 366 is similar in design to the lap belt retractor 348. The lap belt retractor 366 also includes a rewind spring (not shown) and a locking mechanism (not shown). The rewind spring is connected with the spool 368 and applies a force to the spool for rotating the spool in a direction for retracting lap belt 334. The locking mechanism is of a known design and is responsive to a predetermined deceleration of the vehicle 312 for preventing rotation of the spool of the lap belt retractor in a direction enabling withdrawal of lap belt 334. Alternatively, the locking mechanism may be responsive to a predetermined acceleration of the spool 368.

Lap belt 334, between the buckle assembly 342 and the lap belt retractor 366, includes a vertically extending portion 370 and a horizontally extending portion 372. Lap belt 334 transitions from the vertically extending portion 370 to the horizontally extending portion 372 at a turning loop 374. The turning loop 374 guides lap belt 334 relative to the seat 310 during the transition from the vertically extending portion 370 to the horizontally extending portion 372.

The turning loop 374 is located on a right side of the cushion portion 316 of the seat 310. The turning loop 374 is attached to the right side of the seat 310 with a breakaway connector (not shown). The breakaway connector is designed to secure the turning loop 374 relative to the seat 310 during normal use of the four-point seat belt system 330. Preferably, the turning loop 374 is a D-ring. The turning loop 374 is a point of primary loading between lap belt 334 and the seat 310. Thus, the turning loop 374 is an anchor as defined herein.

The turning loop 374 is connected with a pretensioner 376. The pretensioner 376 is located directly below the turning loop 374. The pretensioner 376 is identical in design to the pretensioner 356. An anchor cable 378, such as a braided metal cable, extends between the turning loop 374 and the pretensioner 376. The pretensioner 376 is actuatable for pulling turning loop 374 downward, as viewed in FIG. 8. When the pretensioner 376 is actuated, the downward force exerted on the turning loop 374 causes the breakaway connector to break and enable downward movement of the turning loop 374.

Each of the shoulder belts 336 and 338 of the four-point seat belt system 330 extends outwardly from the upper portion 324 of the backrest portion 320 of the seat 310. Shoulder belt 336 is associated with a left shoulder of the seated occupant 318, and shoulder belt 338 is associated with the right shoulder of the seated occupant.

Shoulder belt 336 has a first end (not shown) that is connected to a shoulder belt retractor 390. As shown in FIG. 8, the shoulder belt retractor 390 is mounted to the frame 314 of the backrest portion 320 of the seat 310. A second end 392 of shoulder belt 336 is attached to the first portion 344 of the buckle assembly 342. When the occupant 318 is seated in the seat 310, as shown in FIGS. 7 and 8, shoulder belt 336 extends over the left shoulder of the occupant 318.

Shoulder belt retractor 390 includes a spool 394 (FIG. 8). The first end of shoulder belt 336 is secured to the spool 394 of shoulder belt retractor 390 and a portion of shoulder belt 336 is wound around the spool. Shoulder belt retractor 390 also includes a rewind spring (not shown) and a locking mechanism (not shown). The rewind spring is connected with the spool 394 and applies a force to the spool for rotating the spool in the clockwise direction, as viewed in FIG. 8. The locking mechanism is of a known design and is responsive to a predetermined deceleration of the vehicle 312 or a predetermined acceleration of the spool 394 for preventing rotation of the spool of the shoulder belt retractor 390 in a counter-clockwise direction, as viewed in FIG. 8.

Shoulder belt 338 has a first end (not shown) that is connected to a shoulder belt retractor 398. The shoulder belt retractor 398 is mounted to the frame 314 of the backrest portion 320 of the seat 310 and is similar in design to the shoulder belt retractor 390. A second end 400 of shoulder belt 338 is attached to the second portion 364 of the buckle assembly 342. When the occupant 318 is seated in the seat 310, as shown in FIG. 7, shoulder belt 338 extends over the right shoulder of the occupant 318.

The buckle assembly 342 includes a buckle switch, shown schematically at 404, for indicating a latched condition of the buckle assembly 342. When the first portion 344 of the buckle assembly 342 is latched to the second portion 364, the buckle switch 404 outputs an electronic signal indicating the latched condition of the buckle assembly 342. The electronic signal may be transferred through a wire, shown schematically at 406 in FIG. 8, that may be embedded in the webbing of one of the lap belts 332 or 334. Alternatively, the electronic signal may be transferred by wireless communication such as by a radio frequency signal.

As shown in FIGS. 7 and 8, the four-point seat belt system 330 also includes a crash sensor 410. The crash sensor 410 is a known device that senses a vehicle condition indicating the occurrence of a crash. Such a condition may comprise, for example, vehicle deceleration. The crash sensor 410 outputs signals indicative of the crash condition.

As is shown schematically in FIG. 7, the pretensioners 356 and 376 are electrically connected to a controller 412. The controller 412 is preferably a microcomputer that receives signals from the crash sensor 410 and runs a known algorithm for determining when seat belt tensioning is desirable. Actuation of the pretensioners 356 and 376 only occurs at conditions in which the locking mechanisms of the lap belt retractors 348 and 368 have already been actuated to block further withdrawal of the lap belts 332 and 334, respectively. When the controller 412 determines that seat belt tensioning is desirable, the controller 412 outputs actuation signals to the pretensioners 356 and 376 to actuate the pretensioners 356 and 376 simultaneously. In response to the actuation signal from the controller 412, the pretensioner 356 is actuated to pull turning loop 354 downward, to the position shown in FIG. 9, to tighten the lap belt 332 across the lap of the occupant 318. Similarly, in response to the actuation signal from the controller 412, the pretensioner 376 is actuated to pull turning loop 374 downward to tighten lap belt 334 across the lap of the occupant 318.

The controller 412 is responsive to the electric signal from the buckle switch 404 for determining whether to actuate the pretensioners 356 and 376. If the controller 412 receives a signal indicating that the buckle assembly 342 is not latched, the controller 412 prevents actuation of the pretensioners 356 and 376. If the controller 412 receives a signal indicating that the buckle assembly 342 is latched, the controller 412 enables actuation of the pretensioners 356 and 376.

Since pretensioner 376 is identical to pretensioner 356, the simultaneous actuation of the pretensioners 356 and 376 applies equal forces to lap belts 332 and 334 so as to pull the buckle assembly 342 downward along the centerline C (FIG. 7) of the occupant 318 of the seat 310. Thus, the four-point seat belt system 330 of the present invention, upon actuation of the pretensioners 356 and 376, maintains the buckle assembly 342 in a centered position relative to the occupant 318 for helping to restrain the occupant in the seat 310.

FIG. 10 is a side view of a four-point seat belt system 330′ that is similar to the four-point seat belt system 330 of FIG. 7 and illustrates an alternative location for the pretensioners. The structures of FIG. 10 that are identical to or similar to structures in FIGS. 7-9 are identified by similar reference numbers followed by a prime.

FIG. 10 only shows pretensioner 356′ on the left side of the seat 310′. A second pretensioner (not shown) is located in a similar location on the right side of the seat 310′. Pretensioner 356′ is located rearward and slightly below, as viewed in FIG. 10, the turning loop 354′. When actuated, the pretensioner 356′ pulls the turning loop 354′ rearward and downward. The rearward and the downward movement of the turning loop 354′ pulls the buckle assembly 342′ rearward and downward to help maintain the occupant 318′ in the seat 310′.

The lap belt retractor, shown schematically at 348′, for lap belt 332′ is pivotally mounted to the frame 314′ of the seat 310′ in a location under the cushion portion 316′ of the seat. The pivotal mounting enables the lap belt retractor 348′ to rotate about an axis, shown as B in FIG. 10, that extends perpendicular to the direction of movement of the turning loop 354′.

In addition to a pivotal connection, at least one shear pin (not shown) secures the lap belt retractor 348′ to the frame 314′ of the cushion portion 316′ of the seat 310′. The shear pin maintains alignment of the lap belt retractor 348′ with the turning loop 354′ during normal operation of the four-point seat belt system 330′.

When the pretensioner 356′ is actuated, the webbing of lap belt 332′ that extends between the turning loop 354′ and the lap belt retractor 348′ creates a moment or pivotal force that tends to rotate the lap belt retractor 348′ about axis B. The shear pin is designed to shear in response to a predetermined pivotal force to enable pivotal movement of the lap belt retractor 348′ about axis B to maintain alignment with the turning loop 354′.

The second lap belt retractor for a second lap belt on the right side of the seat 310′ is similarly mounted to the seat and pivots relative to the seat in a similar manner as a result of actuation of the second pretensioner. The pivoting of the lap belt retractors, only one of which is shown at 348′, prevents an undesirable lateral loading of the lap belt retractors and prevents the lap belts (only lap belt 332′ being shown) from bunching in the openings of the respective lap belt retractors as a result of actuation of the pretensioners.

From the above description of the invention, those skilled in the art will perceive improvements, changes and modifications. For example, in the four-point seat belt system 30 illustrated in FIGS. 1 and 2, the anchors 42 and 102 may be located near the hinge 22 and the tubular belt guides 52 and 104 leading to lap belt retractor 50 may be located near a midpoint of the cushion portion 16 of the seat 10. Additionally, the occupant restraint system 330 illustrated in FIGS. 7 and 8 may be modified to use a pretensioner similar to the pretensioner 190 illustrated in FIGS. 5 and 6 with anchor cables connecting the turning loops to the drum of the pretensioner. Such improvements, changes and modifications within the skill of the art are intended to be covered by the appended claims.

Having described the invention, we claim the following:

1. An occupant restraint system for helping to protect an occupant of a vehicle, the occupant restraint system comprising:
first and second lap belt portions for collectively extending across a lap of the occupant;
first and second shoulder belt portions for extending over the shoulders of the occupant;
a buckle assembly for interconnecting the lap belt portions and the shoulder belt portions;
first and second lap belt anchors for the first and second lap belt portions, respectively, and for transferring loads from the first and second lap belt portions;
at least one pretensioner connected with the first and second lap belt anchors and actuatable to move the first and second lap belt anchors for tensioning the first and second lap belt portions;
a crash sensor for sensing a vehicle crash condition; and
a controller responsive to the crash sensor for controlling actuation of the at least one pretensioner, the controller controlling the at least one pretensioner to tension the first and second lap belt portions simultaneously and uniformly.

2. The occupant restraint system of claim 1 further including at least one lap belt retractor for the first and second lap belt portions, the at least one lap belt retractor, in response to a vehicle condition indicative of a vehicle crash, preventing withdrawal of the first and second lap belt portions prior to actuation of the at least one pretensioner.

3. The occupant restraint system of claim 2 wherein the first lap belt portion extends from the first lap belt anchor to the buckle assembly and then extends from the buckle assembly to the at least one lap belt retractor, and the second lap belt portion extends from the second lap belt anchor to the buckle assembly and then extends from the buckle assembly to the at least one lap belt retractor.

4. The occupant restraint system of claim 3 wherein the at least one pretensioner comprises first and second pretensioners, the first pretensioner being connected with the first lap belt anchor and the second pretensioner being connected with the second lap belt anchor, the first and second pretensioners being adapted to tension the first and second lap belt portions uniformly.

5. The occupant restraint system of claim 3 wherein the at least one pretensioner includes a rotatable drum and an actuation mechanism, the actuation mechanism, when actuated, rotating the drum, the first lap belt anchor attaching the first lap belt portion to the drum and the second lap belt anchor attaching the second lap belt portion to the drum, the first and second lap belt portions being wound onto the drum during rotation of the drum and moving the first and second anchors.

6. The occupant restraint system of claim 2 wherein the first lap belt anchor is a first turning loop and the second lap belt anchor is a second turning loop, the first lap belt portion extending from the at least one retractor, through the first turning loop, and to the buckle assembly, and the second lap belt portion extending from the at least one retractor, through the second turning loop, and to the buckle assembly.

7. The occupant restraint system of claim 6 wherein the at least one pretensioner comprises first and second pretensioners, the first pretensioner being connected with the first turning loop and the second pretensioner being connected with the second turning loop, the first and second pretensioners being adapted to tension the first and second lap belt portions uniformly.

8. The occupant restraint system of claim 6 wherein the at least one lap belt retractor comprises a first lap belt retractor associated with the first lap belt portion and a second lap belt retractor associated with the second lap belt portion, the first and second lap belt retractors being pivotal relative to a seat of the vehicle, and
the at least one pretensioner comprises first and second pretensioners, the first pretensioner being connected with the first turning loop and the second pretensioner being connected with the second turning loop, the first and second pretensioners being adapted to move the first and second turning loops, respectively, rearward relative to the seat,
the first lap belt retractor pivoting relative to the seat in response to the rearward movement of the first turning loop and the second lap belt retractor pivoting relative to the seat in response to the rearward movement of the second turning loop.

9. The occupant restraint system of claim 1 further including a buckle switch for sensing a condition of the buckle assembly and for providing a buckle signal indicative of the condition of the buckle assembly, the controller receiving the buckle signal and preventing actuation of the at least one pretensioner when the buckle signal indicates an unlatched condition of the buckle assembly.

10. An occupant restraint system for helping to protect an occupant of a vehicle, the occupant restraint system comprising:
first and second lap belt portions for collectively extending across a lap of the occupant;
first and second shoulder belt portions for extending over the shoulders of the occupant;
a buckle assembly for interconnecting the lap belt portions and the shoulder belt portions;
at least one lap belt retractor for the first and second lap belt portions;
first and second turning loops located between the at least one lap belt retractor and the buckle assembly for guiding the first and second lap belt portions, respectively; and
at least one pretensioner connected with the first and second turning loops and actuatable to move the first and second turning loops for tensioning the first and second lap belt portions.

11. The occupant restraint system of claim 10 wherein the at least one lap belt retractor is actuatable to prevent withdrawal of the first and second lap belt portions, the at least one pretensioner being actuatable to move the first and second turning loops for tensioning the first and second lap belt portions only after the at least one lap belt retractor has been actuated.

12. The occupant restraint system of claim 11 wherein the at least one lap belt retractor comprises a first lap belt retractor associated with the first lap belt portion and a second lap belt retractor associated with the second lap belt portion, the first and second lap belt retractors being pivotal relative to a seat of the vehicle, and
the at least one pretensioner comprises first and second pretensioners, the first pretensioner being connected with the first turning loop and the second pretensioner being connected with the second turning loop, the first and second pretensioners being adapted to move the first and second turning loops, respectively, rearward relative to the seat,
the first lap belt retractor pivoting relative to the seat in response to the rearward movement of the first turning loop and the second lap belt retractor pivoting relative to the seat in response to the rearward movement of the second turning loop.

13. The occupant restraint system of claim 11 further including a crash sensor for sensing a vehicle crash condition, and a controller responsive to the crash sensor for controlling actuation of the at least one pretensioner, the controller controlling the at least one pretensioner to tension the first and second lap belt portions simultaneously and uniformly.

14. The occupant restraint system of claim 13 further including a buckle switch for sensing a condition of the buckle assembly and for providing a buckle signal indicative of the condition of the buckle assembly, the controller receiving the buckle signal and preventing actuation of the at least one pretensioner when the buckle signal indicates an unlatched condition of the buckle assembly.

15. The occupant restraint system of claim 11 wherein the first lap belt portion extends through the first turning loop and the second lap belt portion extends through the second turning loop.

16. The occupant restraint system of claim 11 wherein the at least one pretensioner comprises first and second pretensioners, the first pretensioner being connected with the first turning loop and the second pretensioner being connected with the second turning loop, the first and second pretensioners being adapted to tension the first and second lap belt portions simultaneously and uniformly.

17. An occupant restraint system for helping to protect an occupant of a vehicle, the occupant restraint system comprising:
first and second lap belt portions for collectively extending across a lap of the occupant;
a buckle assembly for interconnecting the first and second lap belt portions;
at least one lap belt retractor for the first and second lap belt portions;
first and second turning loops located between the at least one lap belt retractor and the buckle assembly for guiding the first and second lap belt portions, respectively; and
at least one pretensioner connected with at least one of the first and second turning loops and actuatable to move the at least one of the first and second turning loops for tensioning the first and second lap belt portions.

18. The occupant restraint system of claim 17 wherein the at least one lap belt retractor comprises a first lap belt retractor associated with the first lap belt portion and a second lap belt retractor associated with the second lap belt portion, the first and second lap belt retractors being pivotal relative to a seat of the vehicle, and
the at least one pretensioner comprises first and second pretensioners, the first pretensioner being connected with the first turning loop and the second pretensioner being connected with the second turning loop, the first and second pretensioners being adapted to move the first and second turning loops, respectively, rearward relative to the seat,
the first lap belt retractor pivoting relative to the seat in response to the rearward movement of the first turning loop and the second lap belt retractor pivoting relative to the seat in response to the rearward movement of the second turning loop.

19. The occupant restraint system of claim 18 further including a crash sensor for sensing a vehicle crash condition, and a controller responsive to the crash sensor for controlling actuation of the first and second pretensioners, the controller controlling the first and second pretensioners to tension the first and second lap belt portions simultaneously and uniformly.

20. The occupant restraint system of claim 19 further including a buckle switch for sensing a condition of the buckle assembly and for providing a buckle signal indicative of the condition of the buckle assembly, the controller receiving the buckle signal and preventing actuation of the first and second pretensioners when the buckle signal indicates an unlatched condition of the buckle assembly.
